(19) United States
(12) Patent Application Publication
(10) Pub. No.: US 2014/0364172 A1
(43) Pub. Date: Dec. 11, 2014

(54) METHOD AND APPARATUS FOR CONTROLLING CALL IN PORTABLE TERMINAL

(71) Applicant: Samsung Electronics Co., Ltd., Gyeonggi-do (KR)

(72) Inventors: Kwangmin KIL, Gyeonggi-do (KR); Huncheol OH, Seoul (KR)

(73) Assignee: Samsung Electronics Co., Ltd.

(21) Appl. No.: 14/302,100

(22) Filed: Jun. 11, 2014

(30) Foreign Application Priority Data
Jun. 11, 2013 (KR) 10-2013-0066291

(51) Int. Cl. H04M 1/725

(52) U.S. Cl. CPC H04M 1/72583
USPC 455/566

(57) ABSTRACT

A method and apparatus for controlling an incoming call in the portable terminal are provided. The method includes displaying a call mode selection screen at a time an incoming call is detected; recognizing the call mode which is selected from the call mode selection screen; and servicing the incoming call in the selected call mode.

### PRIORITY

This application claims priority under 35 U.S.C. §119(a) to a Korean Patent Application filed on Jun. 11, 2013 in the Korean Intellectual Property Office and assigned Serial No. 10-2013-0066291, the entire content of which is hereby incorporated herein by reference.

### BACKGROUND OF THE INVENTION

1. Field of the Invention

The present invention relates to a method and apparatus for controlling a call in a portable terminal, and more particularly, to a method and an apparatus for controlling an incoming call in a portable terminal.

2. Description of the Related Art

Due to the development of information communication and semiconductor technologies, for example, functions of portable terminals have become increasingly diverse. In particular, portable terminals may provide various functions such as a voice recording function, a wireless headset connecting function, a memo writing, and a speaker call function during a call.

However, the above-described call functions are selected after the portable terminal has already started performing the call. For example, when an incoming call is received, a desired call function is selected after performing the normal call mode when the incoming call is generated. Therefore, when a user desires to perform the call function in a specific call mode, the user must execute the call function first, and then perform additional operation such as an icon selection and a menu tree entry in order to change the call mode into the user's desired specific call mode. Therefore, a conventional call service method cannot be performed in the desired specific call mode at the time the call is started. In addition, it may be difficult for the user to perform additional operations to change to the desired call mode according to a call environment of user operating the portable terminal.

### SUMMARY OF THE INVENTION

Accordingly, the present invention has been made to address at least the above problems, and to provide at least the advantages described below. Accordingly, an aspect of the present invention is to provide a method and an apparatus for performing a user's desired call mode at a call start time point without changing a call mode through a plurality of key inputs.

In accordance with an aspect of the present invention, a method for controlling a call mode in a portable terminal is provided. The method includes displaying a call mode selection screen at a time an incoming call is detected; recognizing the call mode which is selected from the call mode selection screen; and servicing the incoming call in the selected call mode.

In accordance with another aspect of the present invention, an apparatus for controlling a call mode in a portable terminal is provided. The apparatus includes a wireless communication unit configured to detect a generation of an incoming call; a display unit configured to display a call mode selection screen according to the detected generation of the incoming call; a touch panel configured to detect a touch generated on the call mode selection screen; a controller configured to determine whether the detected touch selects a specific call mode and requests a command to start a call, and further configured to starts the call in the selected call mode when the touch is determined to select the specific call mode and request the command to start the call; and a storage unit configured to store a program that starts the call in the selected specific call mode according to the touch.

### BRIEF DESCRIPTION OF THE DRAWINGS

The above and other aspects, features, and advantages of the present invention will be more apparent from the following detailed description in conjunction with the accompanying drawings, in which:

FIG. 1 is a block diagram schematically illustrating a configuration of a portable terminal according to various embodiments of the present invention;

FIG. 2 is a flowchart illustrating a procedure performing a call function by selecting a call mode in a portable terminal according to various embodiments of the present invention;

FIG. 3 is a diagram illustrating a screen where a call mode selection menu according to an embodiment of the present invention is displayed;

FIG. 4 is a diagram illustrating a procedure starting a call in a speaker mode in a circular call mode selection menu according to an embodiment of the present invention;

FIG. 5 is a diagram illustrating another example of a method of starting a call through use of a call mode selection menu of FIG. 4;

FIG. 6 is a diagram illustrating a screen where a call mode selection menu according to an embodiment of the present invention is displayed; and

FIG. 7 is a diagram illustrating a screen where a call mode selection menu according to an embodiment of the present invention is displayed.

### DETAILED DESCRIPTION OF EMBODIMENTS OF THE PRESENT INVENTION

Hereinafter, embodiments of the present invention are described in detail with reference to the accompanying drawings. The same reference numbers may be used throughout the drawings to refer to the same or like parts. Detailed descriptions of well-known functions and structures incorporated herein may be omitted to avoid obscuring the subject matter of the present invention.

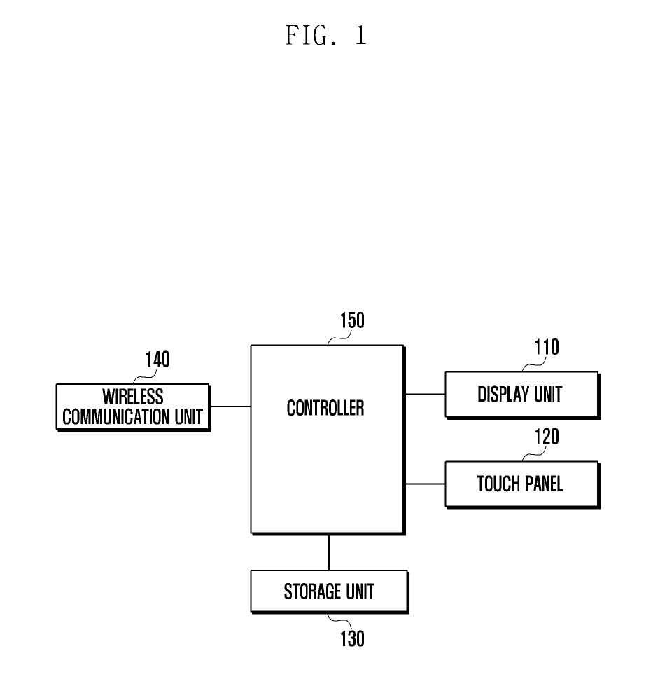

FIG. 1 is a block diagram schematically illustrating a configuration of a portable terminal according to various embodiments of the present invention.

Referring to FIG. 1, the portable terminal according to an embodiment of the present invention includes a display unit 110, a touch panel 120, a storage unit 130, a wireless communication unit 140, and a controller 150. The display unit 110 and the touch panel 120 may be disposed integrally together in a same touch screen.

The display unit 110 may be an Organic Light Emitting Diode (OLED) display or an Active Matrix Light Emitting Diode (AMOLED) display, and provides various visual information such as a menu, input data, and function setting information of the portable terminal to the user. The display unit 110 displays an incoming notification screen that includes a call mode selection menu to the user at the time of the incoming call generation. The call mode selection menu is an icon-type menu used to configure various call modes supported by the portable terminal. The display unit 110 may also display the call mode selected from the call mode selection menu on the screen. Furthermore, when a call is performed in a specific call mode (e.g., a memo mode, a keypad display mode, etc.), the display unit 110 may display a screen corresponding to the call mode.

The touch panel 120 is a device that detects a user's touch input. The touch panel 120 may operate in a capacitive overlay method, a resistive overlay method, and an infrared beam method, etc. In addition to, or as an alternative, to the above-listed examples, other methods that may detect a contact or a pressure of an object may be configured with the touch panel 120, in accordance with embodiments of the present invention. The touch panel 120 is able to detect both a user's touch input, and a location where the touch is generated. In addition, the touch panel 120 may additionally include an electromagnetic induction-type touch panel that detects only a touch input of a specific touch apparatus. The touch panel 120 according to an embodiment of the present invention detects various touch inputs including a user's touch gesture input to select the call mode and as well as an input to execute the call function. The call mode being selected at this time may be the call mode that is indicated at a location on a screen corresponding to a starting point of the user's touch gesture. In addition, a drag and a long touch lasting for a certain period of time may be included in the touch gesture that initiates execution of the call function. Further, when the call function is performed in a specific call mode (e.g., a memo mode, etc.)that requests additional touch input, the touch panel 120 may detect the additional touch input from a user's body or touch tools, such as the specific touch apparatus described above.

The storage unit 130 stores a program and data that are used during operation of the portable terminal. According to an embodiment of the present invention, an application program controlling the start a call, in a call mode selected by the user, is also stored in the storage unit 130. According to an embodiment of the present invention, the storage unit 130 also stores commands and data that are necessary to display the call mode selection menu on the screen. According to an embodiment of the present invention, the storage unit 130 also stores data related to configuration of the call mode selection menu and data related to gesture settings for starting a call.

The wireless communication unit 140 performs wireless communication functions of the portable terminal. The wireless communication unit 140 may include, for example, a Radio Frequency (RF) transmission unit that performs up-conversion and amplification of a frequency of a transmitted signal, and a radio frequency reception unit that performs low noise amplification and down-conversion of a received signal. The wireless communication unit 140 may include a mobile communication module, such as a Long Term Evolution (LTE) or a Code Division Multiple Access (CDMA) communication module, a digital broadcasting module, such as a Digital Multimedia Broadcasting (DMB) or a Digital Video Broadcasting (DVB) module, a wireless internet communication module, such as a Wife or Wireless Broadband (Wibro) module, and a short distance communication module, such as a Near Field Communication (NFC) or a Bluetooth module. The wireless communication unit 140 detects incoming calls received by the portable terminal. The wireless communication unit 140 may also support the call function performance through the short distance communication module, when the call function is performed in a specific corresponding call mode (e.g., a wireless headset connection function). The wireless communication unit 140 also performs overall wireless communication functions.

The controller 150 controls overall operations of the portable terminal and signal flows between internal components of the portable terminal, and also performs data processing functions for processing data. The controller 150 controls the display of an incoming call notification screen that includes a call mode selection menu on the display unit 110 upon detecting an incoming call received through the wireless communication unit 140, and may also control output of an image and/or a sound according to the incoming call. The controller 150 recognizes commands corresponding to the call mode selection of a user and further corresponding to a start of the call, received through the touch panel 120, in a state in which the incoming call notification screen is displayed. The controller 150 also services the incoming call in the corresponding call mode by detecting the call mode selection according to the output of the touch panel 120. The call mode selection menu displayed on the incoming call notification screen may include options to select a normal mode, a received sound blocking mode, a speaker mode, a recording mode, a wireless headset connection mode, a memo mode, a transmitted sound blocking mode, and a keypad display mode, etc.

The normal mode is a mode in which calls to another party are performed by using a microphone and a receiver that is normally designated in a portable terminal. Further, the received sound blocking mode is a function that deactivates a receiver function. Through this mode, the portable terminal blocks the other party's voice that would otherwise be heard through the receiver in the portable terminal. In addition, the speaker mode is a function that outputs the other party's voice to a speaker instead of the receiver when the call is connected. Therefore, in the speaker mode, the user is able to hear the other party's voice much louder than when in the normal mode. In addition, the recording mode provides a function for recording the call audio. At this time, the recorded call audio may be stored in the storage unit 130 of the portable terminal as a type of audio file. In addition, the wireless headset connecting mode refers to a mode where the call function is performed through the wireless headset that is connected by using the short distance wireless communication such as a Bluetooth, etc. When executing the wireless headset connecting mode, the controller 150 of the portable terminal searches for and connects a wireless headset based on a list or setting information regarding a connectable wireless headset device. In this mode, the user is able perform the call through use of the headset call mode even though a headset calling mode was not previously set. When the wireless headset connecting mode is executed through the above mentioned wireless headset connecting procedure, the functions of the microphone and the receiver mounted on the portable terminal are replaced by the functions of the microphone and the receiver of the wireless headset, respectively. Accordingly, in the wireless headset connecting mode, a user is able to perform the call function through the wireless headset during the call. The memo mode is a mode supporting use of memo function while the call function is performed. When the call is performed in the memo mode, the controller 150 controls display of, for example, a memo display window and a keypad on the display unit 110, as well as a memo input through the touch pad 120. The transmitted sound blocking mode is a mode in which the microphone function is deactivated while the call function is performed. Depending on the user's situations at the time a phone call is received, the user may want to completely block the transmission of sound at the time point of receiving the call, but activate the microphone function at a later time. The keypad display mode is a mode in which the keypad is displayed on the display unit 110 while the call function is being performed.

The controller 150 may verify the call mode selected through the starting point of the touch gesture detected in the touch panel 120. In addition, the controller 150 may verify the touch gesture detected in the touch panel 120, and may determine whether the gesture is also a command to start the call. The controller 150 starts the call function when the detected touch gesture is a request to start the call. The controller 150 is also able recognize whether a touch input requesting a call mode change is received while the call function is performed, and performs the call function while changing the current call mode into the call mode corresponding to the touch input.

The controller 150 also controls various operations related to the normal function of the portable terminal.

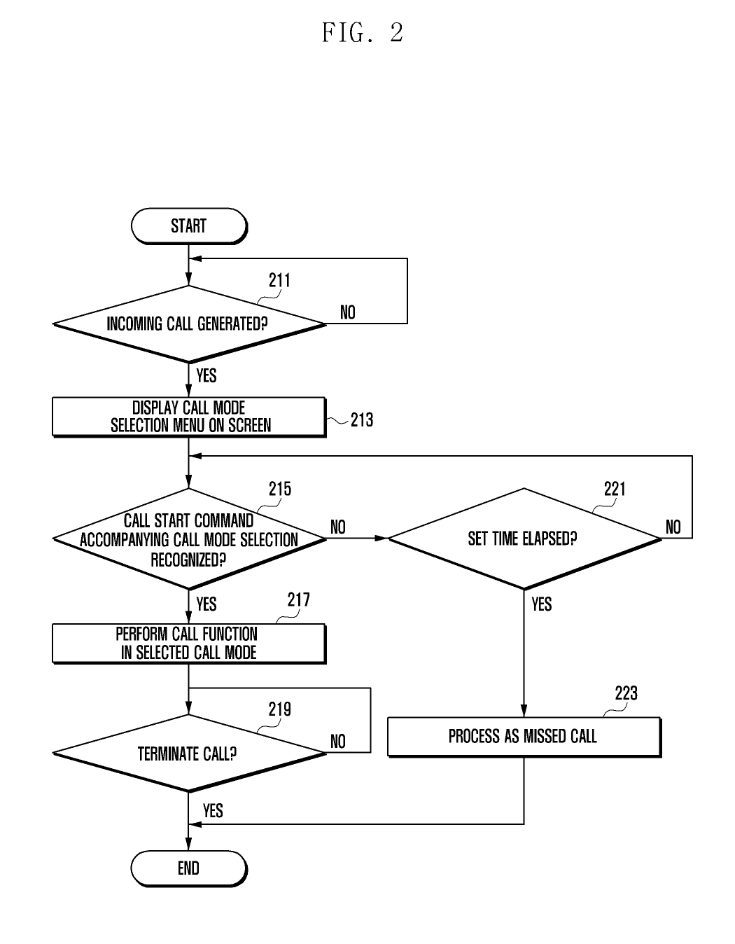

Hereinafter, a procedure of performing the call function by selecting the call mode in the portable terminal according to various embodiments of the present invention is described with reference to FIGS. 2 to 4.

FIG. 2 is a flowchart illustrating a procedure performing a call function by selecting a call mode in a portable terminal according to various embodiments of the present invention.

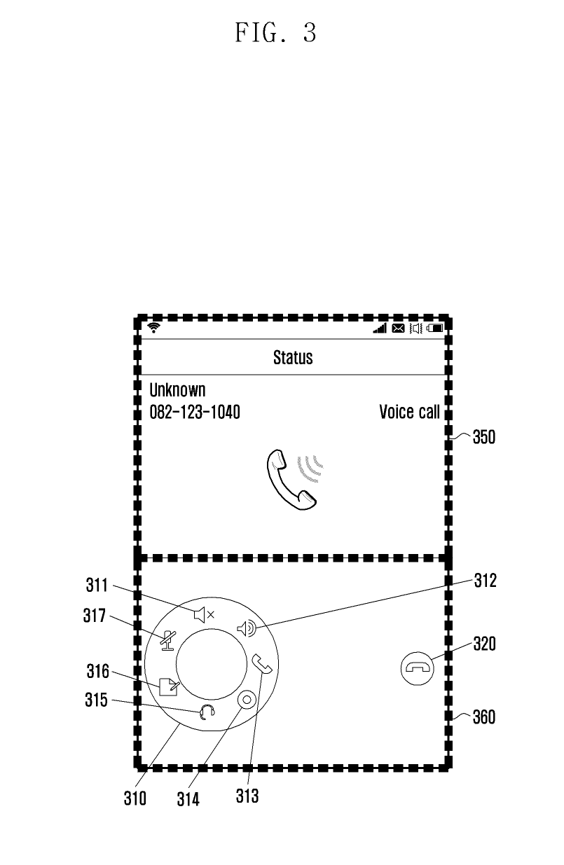

Referring to FIGS. 1-3, the controller 150 determines whether an incoming call is received through the wireless communication unit 140 at step 211. When the incoming call is not received, the controller 150 does not proceed to the next operation. However, when receipt of an incoming call is detected at step 211, the controller 150 displays the call mode selection menu 310 on the display unit 110. As shown in FIG. 3, the screen notifying the incoming call on the screen is divided into a first display area 350 notifying a user of the incoming call status and a second display area 360 displaying the call mode selection menu. An animation displaying a caller ID or a notification of the incoming call are displayed on the first display area 350, and the call mode selection mode 310 and a hang up button 320 may be displayed on the second display area 360. Various call modes, such as a speaker mode, a received sound blocking mode, and a recording mode, etc. are displayed on the call mode selection menu 310 as icons, and the configuration of the types of displayed call mode icons may be changed according to user settings. While displaying the call mode selection mode 320, the controller 150 may detect the selection of the call mode through the touch panel 120. More specifically, the controller 150 may perform this detection by determining whether the user's request for selecting the call mode and starting the call is input at step 215. At this time, the selection of the specific call mode is performed by verifying the call mode according to the position of a touch input detected in the touch panel 120 by the controller 150. A user's gesture to start the call may also be performed by a single touch input that is also used select the call mode. Accordingly, when such an input is provided, the user may select the call mode by executing only a single touch gesture, and the controller 150 performs the incoming call service in the selected call mode when detecting the call mode selection. Alternatively, the controller 150 may be set such that a request for call mode selection and a request to start a call are only received through a touch input execution that does not accompany a specific touch gesture. More specifically, according to this setting, a call is automatically started when a certain period of time elapses in a state in which a user input selecting the call mode is received. The method of automatically starting the call when a setting time has elapsed after a touch input is received can be set or released according to a user's selection. For example, the user may set a time (e.g., 3 seconds) from a time point where the user selects the call mode to the time point where the call is automatically started. The controller 150 determines whether a setting time has elapsed, when the controller does not recognize a touch input for selecting a call mode and or an input for starting the call, at step 221. When the setting time has elapsed without input of a touch gesture for selecting a call mode or starting the call starting, after the incoming call is generated, the controller 150 processes this call as a missed call, at step 223. After step 223, the controller 150 terminates a call function performing procedure of FIG. 2. However, after determining that the setting time has not elapsed at step 221, the controller 150 returns to step 215.

When an input of a user's touch gesture to select the call mode and to start the call is recognized at operation 215, the controller 150 performs the call function in the selected call mode at step 217. The selected specific call mode can be canceled and changed while the call function is performed. When an input requesting the call termination is detected through the touch panel 120 at step 219, the controller 150 terminates the procedure of FIG. 2.

FIG. 3 is a diagram illustrating a call mode selection menu screen according to an embodiment of the present invention.

Referring to FIG. 3, the incoming notification screen including the call mode selection menu 310 having a configuration as shown in FIG. 3 may be displayed during step 213 of FIG. 2. The incoming notification screen includes a first display area 350 and a second display area 360. The first display area 350 notifies a user that the incoming call is generated and is displayed on an upper part of a screen. The incoming number is also displayed on the first display area 350. When the caller information corresponding to the incoming number is stored in the storage unit 130, the caller information (e.g., caller's name, and a photo, etc.) are also displayed on the first display area 350. Furthermore, the second display area 360 is a part of the screen in which the call mode selection menu 310 and the hang up button 320 are displayed, and is displayed on a bottom part of the screen. The various call modes supported by the portable terminal are displayed on the call mode selection menu 310. More specifically, a received sound blocking mode 311, a speaker mode 312, a normal mode 313, a recording mode 314, a wireless headset connecting mode 315, a memo mode 316, and a transmitted sound blocking mode 317 are displayed in the call mode selection menu 310 as icons. In addition, the configuration of the call modes displayed on the call mode selection menu 310 may be changed according to the user's settings. For example, the user may configure the call mode selection menu 310 to include only the specific modes frequently used by the user. Although the call mode selection menu 310 is displayed as a circle in FIG. 3, embodiments of the present invention are not limited to this configuration. Various alternative examples of types of the call mode selection menu 310 according to embodiments of the present invention are described later herein. Further, the incoming notification screen also includes the hang up button 320. The hang up button 320 may be used in order for the user to reject an incoming call. Touch input gestures may be used as command input methods corresponding to the call mode selection menu 310 and hang up button 320.

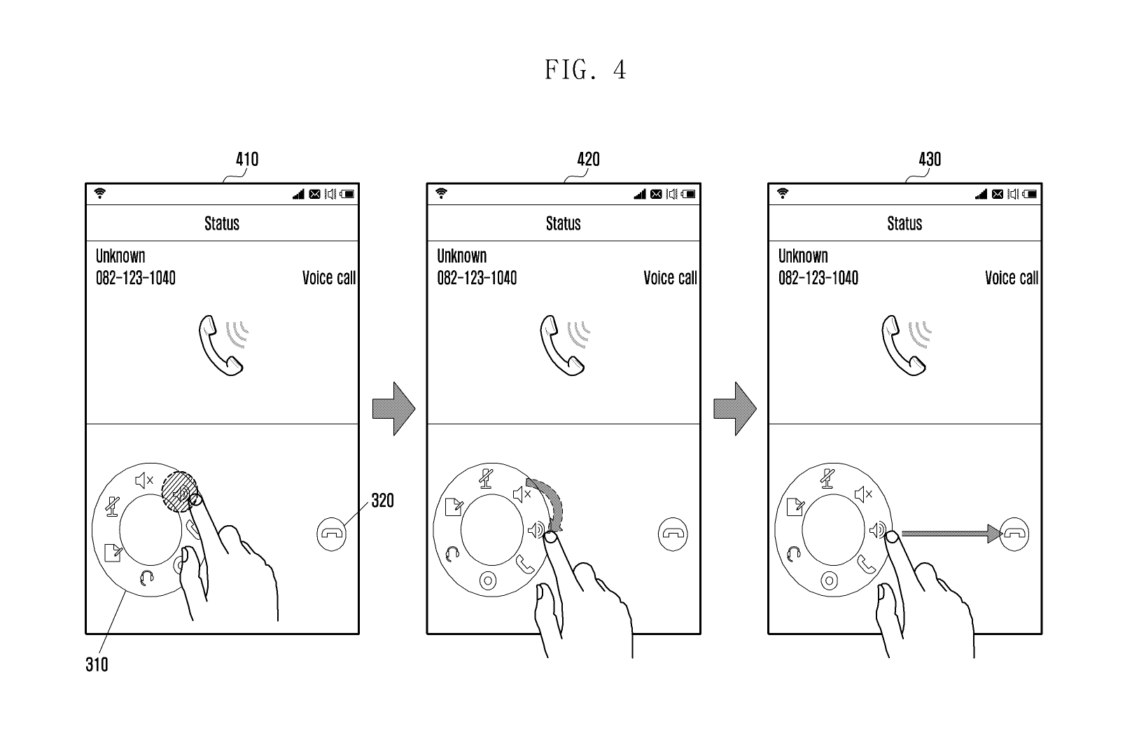

FIG. 4 is a diagram illustrating a procedure starting a call in a speaker mode in a circular call mode selection menu according to an embodiment of the present invention.

Referring to FIG. 4, when detecting an incoming call, the controller 150 controls display of an indication that the incoming call has been generated and incoming call information on the first display area 350 of the display unit 110, as illustrated in screen 410 of FIG. 4. The controller 150 also controls display of a screen for selecting the call mode of the incoming call on the second display area 360, at step 213. Screen 410 of FIG. 4 illustrates an example a user selection of an icon of a speaker mode in the call mode selection menu 310. When the user inputs the specific touch gesture (e.g., a drag) while maintaining a touch corresponding to a icon selected by the user as in screen 420, the controller 150 rotates the call mode icons displayed on the display unit 110 within the area of the call mode selection menu 310, and moves the respective positions of the call mode icons. In addition, when the user stops the touch operation of the icon selected by the user at a specific point, the controller 150 stops the rotation movement of the icon on the display unit 110. Further, when the user performs a drag operation heading towards an outside of the screen of the call mode selection menu 310 while selecting the specific call mode icon, as in screen 430, the controller 150 detects a drag operation through the touch panel 120 at step 215, and sets the call mode indicated at a location where the drag is detected as the call mode of the incoming call, at step 217. Screen 430 illustrates an example in which the termination point of the touch gesture of the user to select the call mode is the hang up button 320. All of touch inputs and the touch gestures described with reference to FIG. 4 may be achieved with one consecutive movement instead of divided movements. Further, when the touch gesture is terminated at the location of the hang up button 320, such as in screen 430, the controller 150 recognizes the call starting command accompanying the call mode selection at step 215, and controls the wireless communication unit 140 to start the call in the speaker mode at step 217.

The example of FIG. 4 only corresponds to a case in which the call is started in the speaker mode. However, the call can be started in different call modes through the above-described method. The touch gesture to start the call described with reference to FIG. 4 applies to an example where the touch input is terminated at the position of the hang up button 320. However, embodiments of the present invention are not limited to such a touch gesture, and several additional examples of touch gestures corresponding to the call mode selection menu 310 are described herein and shown throughout the drawings.

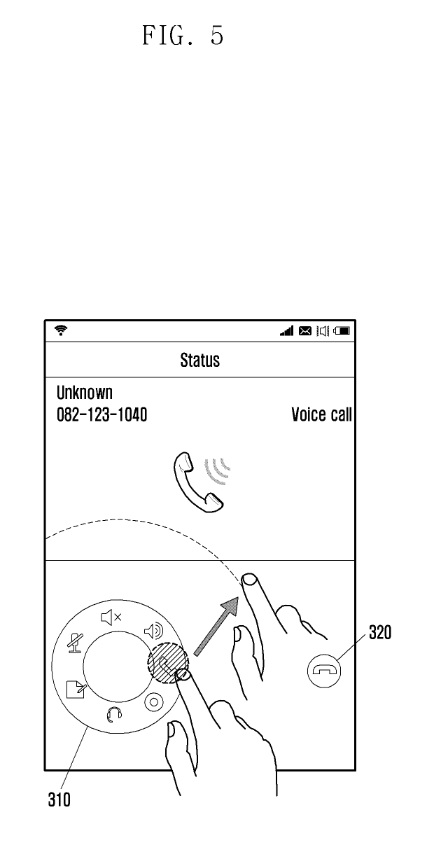

FIG. 5 is a diagram illustrating different example of a method starting a call in a call mode selection menu 310 in FIG. 4 according to an embodiment of the present invention.

Referring to FIGS. 1, 2, 4, and 5, according to an embodiment of the present invention, the incoming notification screen illustrated in FIG. 5 is displayed at step 213. The user starts the call by performing the touch gesture (e.g., a drag and drop) in an arbitrary direction after selecting the specific call mode by the touch, as illustrated in FIG. 5. In particular, the call starting method illustrated in FIG. 5 is set to be performed when a distance from the touch input point (i.e., a location of the specific call mode icon) to the touch release point of the touch gesture is at least equal to a certain value. The controller 150 performs step 215 of recognizing the call starting command accompanying the specific call mode selection, when a movement distance from the touch input point is at least equal to the certain value. The controller 150 proceeds to perform the call function in the call mode selected at step 217, when the call starting command is recognized. As shown in FIG. 5, the distance from the touch input point may be displayed on the screen as visual data (e.g., a size of a circle) while the touch gesture is performed.

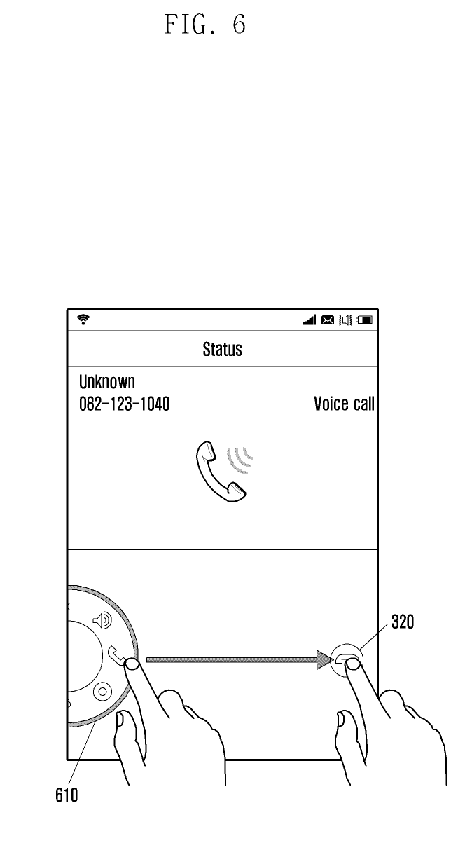

FIG. 6 is a diagram illustrating a screen where a call mode selection menu according to an embodiment of the present invention is displayed.

Referring to FIGS. 1, 2, and 6, according to an embodiment of the present invention, when an incoming call is detected, the controller 150 displays the screen of FIG. 6 at step 213. As shown in FIG. 6, a call mode selection menu 610 has a semicircular shape. A portion of the call mode icons of the call mode selection menu 610 may be displayed on the screen. When a user wants to select the call mode icon that is not displayed on the screen, the user rotates the display area of the icon of the call mode selection menu 610 by performing the touch gesture (e.g., a drag). Thus, the user changes the location of the icons, and call mode icons that were not previously shown on the screen added to the screen. When the user performs the touch gesture (e.g., a drag and drop) in direction towards a hang up button 320 or in an arbitrary direction, after disposing the desired call mode icon on an appropriate location by using the touch gesture, the controller 150 recognizes a call starting command in the selected call mode. As described above, when the touch gesture, which is generated in the location of the specific call mode icon and heads for the outside of the icon display area of the call mode selection menu 610, is generated, the controller 150 performs step 215 of recognizing the call starting command accompanying the call mode selection. The controller 150 then proceeds to perform the call function in the call mode selected at step 217, after recognizing the call starting command.

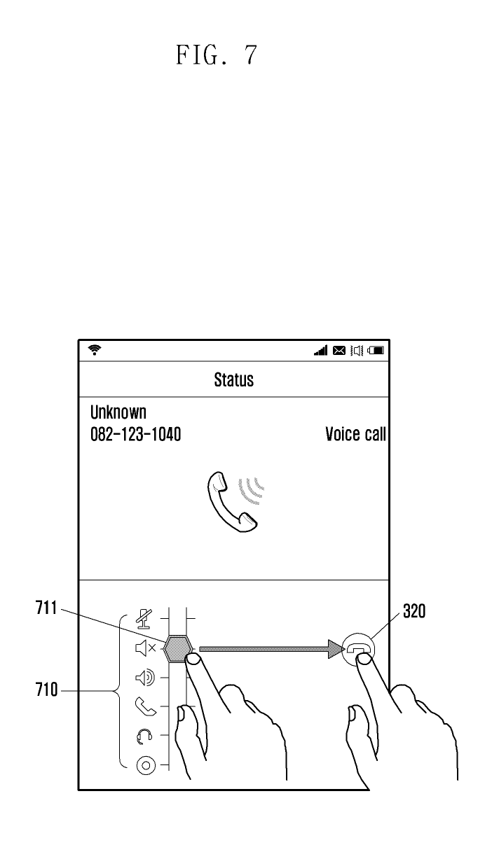

FIG. 7 is a diagram illustrating a screen where a call mode selection menu according to an embodiment of the present invention is displayed.

Referring to FIGS. 1, 2, and 7, according to an embodiment of the present invention, when detecting the incoming call, the controller 150 displays the screen of FIG. 7 on the display unit 110 at step 213. FIG. 7 displays a call mode selection menu 710 in the form of a vertical bar, and each vertically displayed call mode icon is located on a side of the call mode selection menu 710. A graphic tool 711, which is scrolled according to the user's touch gesture (e.g., a drag), is also displayed in the call mode selection menu 710 in a bar shape. When the user wants to start the call by selecting the specific mode in the call mode selection menu 710, the user selects the specific call mode by moving the graphic tool 711. The user then performs a touch gesture to start the call while the touch for moving the graphic tool 711 is maintained. The touch gesture to start the call is touch gesture (e.g., a drag & drop) that heads from the graphic tool 711 towards the hang up button 320, or any other direction. In the example according to FIG. 7, the position of the hang up button 320 is fixed, but the height of the hang up button 320 may change according to the moved position of the graphic tool 711 in accordance with embodiments of the present invention. The controller 150 performs step 215 of verifying whether the call starting command accompanying the call mode selection is recognized through the touch gesture that starts at the graphic tool 711 and terminates at the hang up button 320. The controller 150 then proceeds to step 217 of performing the call function in the selected call mode, when the call start command is recognized.

A portable terminal according to the various embodiments of the present invention display an incoming call notification and icons each corresponding to a respective incoming call mode on the screen when an incoming call is detected, and may provide a corresponding call mode when a displayed call mode icon is selected.

Accordingly, the portable terminal simultaneously performs a selection of a call mode and a call connection, and therefore, a user is able to more easily perform a call that is suitable to a purpose or situation of the call.

Although certain embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims and their equivalents.

What is claimed is:

1. A method for controlling a call mode in a portable terminal, the method comprising:
displaying a call mode selection screen at a time an incoming call is detected;
recognizing the call mode which is selected from the call mode selection screen; and
servicing the incoming call in the selected call mode.

2. The method of claim 1, wherein the call mode selection screen includes an area where a call mode selection menu is displayed and a call start gesture is performed.

3. The method of claim 2, wherein the call mode selection menu includes at least one of a normal mode, a received sound blocking mode, a speaker mode, a recording mode, a wireless headset connecting mode, a transmitted sound blocking mode, and a keypad display mode.

4. The method of claim 2, wherein the call mode selection menu includes icons each indicating a respective call mode, and is displayed in a circular shape, a semicircular shape, or a bar shape.

5. The method of claim 2, wherein, in the call mode selection menu, an icon moves within a menu area as the icon is dragged when the call mode selection menu is displayed in the circular shape or the semicircular shape.

6. The method of claim 2, wherein, in the call mode selection menu, when the call mode selection menu is displayed in the bar shape, the call mode selection menu is displayed together with a graphic tool, and the call mode is selected through a scroll of the graphic tool to select a call mode icon within the area where the call mode selection menu is displayed.

7. The method of claim 1, wherein recognizing the call mode comprises recognizing, as the selected call mode, a mode selected by a touch gesture among call modes displayed on the call mode selection menu screen.

8. The method of claim 7, wherein recognizing the call mode comprises recognizing, by the touch gesture that starts from a call mode icon and is dragged towards an outside of the display area of the call mode selection screen.

9. The method of claim 7, wherein recognizing the call mode comprises automatically recognizing a call start command when a certain period of time elapses after a touch input selecting a specific call mode is received.

10. An apparatus for controlling a call mode in a portable terminal, the apparatus comprising:
a wireless communication unit configured to detect a generation of an incoming call;
a display unit configured to display a call mode selection screen according to the detected generation of the incoming call;
a touch panel configured to detect a touch generated on the call mode selection screen;
a controller configured to determine whether the detected touch selects a specific call mode and requests a command to start a call, and further configured to starts the call in the selected call mode when the touch is determined to select the specific call mode and request the command to start the call; and
a storage unit configured to store a program that starts the call in the selected specific call mode according to the touch.

11. The apparatus of claim 10, wherein the controller controls the display unit to display the call mode selection screen in which a call mode selection menu is displayed and a call start gesture is performed.

12. The apparatus of claim 11, wherein the call mode selection menu includes at least one call mode from among a normal mode, a received sound blocking mode, a speaker mode, a recording mode, a wireless headset connecting mode, a memo mode, a transmitted sound blocking mode, and a keypad display mode.

13. The apparatus of claim 11, wherein the call mode selection menu includes icons each indicating a respective call mode, and is displayed in a circular shape, a semicircular shape, or a bar shape.

14. The apparatus of claim 11, wherein the controller controls an icon to move within a menu area as the icon is dragged, when the call mode selection menu is displayed in the circular shape or the semicircular shape.

15. The apparatus of claim 10, wherein the controller displays the call mode selection menu together with a graphic tool, and controls to select the call mode through a scroll of the graphic tool to select a call mode icon within the area where the call mode selection menu displayed, when the call mode selection menu is displayed as a bar shape.

16. The apparatus of claim 10, wherein the controller recognizes, as the selected call mode, a mode selected by a touch gesture from among the call modes displayed on the call mode selection screen.

17. The apparatus of claim 10, wherein the controller commands a call start in the selected call mode when a touch gesture that starts from a call mode icon and is dragged towards an outside of the display area of the call mode selection screen is recognized.

18. The apparatus of claim 10, wherein the controller automatically recognizes a call start command when a certain period of time elapses after a touch input selecting a specific call mode is received.
